(19) United States
(12) Patent Application Publication
(10) Pub. No.: US 2007/0271250 A1
(43) Pub. Date: Nov. 22, 2007

(54) Basis selection for coding and decoding of data

(76) Inventor: Donald M. Monro, Beckington (GB)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/255,090

(22) Filed: Oct. 19, 2005

(51) Int. Cl. G06F 17/30

(52) U.S. Cl. 707/4; 707/E17.019

(57) ABSTRACT

Embodiments related to coding data using an optimal codebook and/or dictionary, and selection of the entries for the optimal dictionary are disclosed.

### FIELD

This application pertains to the field of coding data, and more particularly, to the field of selection of bases for coding data using transforms and/or matching pursuits.

### BACKGROUND

Digital video and audio services such as transmitting signals, digital images, digital video, and/or audio information over wireless transmission networks, digital satellite services, streaming video and/or audio over the internet, delivering video content to personal digital assistants or cellular phones, and other devices, are increasing in popularity. Therefore data compression and decompression techniques that balance visual fidelity with levels of compression to allow efficient transmission and storage of digital content may be becoming more prevalent.

### BRIEF DESCRIPTION OF THE DRAWINGS

The claimed subject matter will be understood more fully from the detailed description given below and from the accompanying drawings of embodiments which should not be taken to limit the claimed subject matter to the specific embodiments described, but are for explanation and understanding only.

FIG. 1 is a diagram of a system according to an embodiment.

FIG. 2 is a diagram of a system according to an embodiment.

FIG. 3 is a flow diagram of an embodiment of a method for selecting bases.

FIG. 4 is a block diagram of an embodiment of an example bases selection system.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Matching pursuits processes may be used to compress one or multidimensional data, including but not limited to still images, audio, video, and/or digital images. A matching pursuits process may include finding a full inner product between a signal to be coded and each member of a dictionary of basis functions. At the position of the maximum inner product the dictionary entry giving the maximum inner product may describe the signal locally. This may be referred to as an “Atom.” The amplitude is quantized, and the position, quantized amplitude, sign, and dictionary number form a code describing the Atom. For one embodiment, the quantization may be performed using a precision limited quantization method. Other embodiments may use other quantization techniques.

The Atom is subtracted from the signal giving a residual. The signal may then be completely and/or partially described by the Atom plus the residual. The process may be repeated with new Atoms successively found and subtracted from the residual. At any stage, the signal may be completely described by the codes of the Atoms found and the remaining residual.

Matching pursuits may decompose any signal f into a linear expansion of waveforms that may belong to a redundant dictionary D=φ{γ} of basis functions, such that

$$f = {\sum }_{n = 0}^{m - 1} {α}_{n} {φ}_{{γ}_{n}} + {R}^{m} f$$

where R^{m} f is the m^{th} order residual vector after approximating f by m ‘Atoms’ and
αₙ= [symbol] φ_{γ}_{ₙ},Rⁿ f [symbol]
is the maximum inner product at stage n of the dictionary with the n^{th} order residual.

For some embodiments, the dictionary of basis functions may comprise two-dimensional bases. Other embodiments may use dictionaries comprising one-dimensional bases which may be applied separately to form two-dimensional bases. A dictionary of n basis functions in one dimension may provide a dictionary of n² basis functions in two dimensions.

An enhanced, final, and/or optimal bases dictionary may be determined by utilizing a candidate dictionary. The entries of the candidate dictionary may be utilized, along with an empty or partial final dictionary and a portion of a signal to be coded to find the relative maximum or substantially maximum, inner product for each entry in the candidate dictionary. The entry with the relative maximum inner product may then be removed from the candidate dictionary and placed into an optimal and/or final dictionary. The maximum or substantially maximum inner products for the remaining entries from the candidate dictionary may be calculated similarly to find the one with the next largest, or nearly largest, inner product. In this manner the final dictionary grows by the successive selection of best and/or substantially the best candidate bases. This process may be continued until a threshold has been reached, such as a certain number of bases in the final dictionary, or where the maximum or nearly maximum inner product is below a predetermined value.

The relative or substantially maximum inner product may be within the top 10 inner products, top 15% of all inner products calculated, or above a predetermined threshold for the inner product. The substantially optimal or substantially best entry may be the entry with the relative or substantially maximum inner product. The final dictionary may be optimal in that is contains a relatively low number of entries, such as 15 or below. Furthermore the final dictionary may be substantially optimal in that is my reduce bit rate, calculations, and/or reduce a compression ratio. The final dictionary may not be strictly optional as to find a fully optional dictionary of b bases from n candidates would involve trying all n*b combinations for the training data set. This would require geological timescales on even the fastest available computers for realistic dictionary sizes and so may take substantial amounts of time. On the other hand the selection process disclosed herein delivers substantially optimal dictionaries in feasible times of a few weeks on ordinary PC computers.

This final dictionary may be used on a signal, or data that has been transformed, such as a wavelet transform. Furthermore, the final dictionary may be utilized to code data with matching pursuits. This process may also be used with other data, including audio, visual, video, multidimensional, and/or non-transformed data. Furthermore, the final, optimal, and or near optimal dictionary may be used to code many different types of transformed and non-transformed data. Yet further, this method and system may be utilized to determine final, optimal, and or near optimal dictionaries and/or codebooks for many different types of data coding.

For compression, the matching pursuits process may be terminated at some stage and the codes of a determined number of Atoms are stored and/or transmitted by a further coding process. For one embodiment, the further coding process may be a lossless coding process. Other embodiments may use other coding techniques, including non-lossless coding techniques.

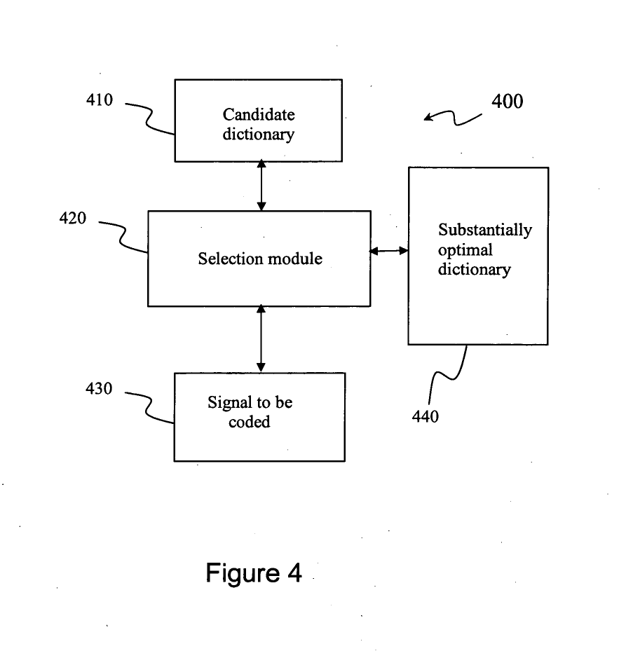

An image may be represented as a two-dimensional array of coefficients, each coefficient representing intensity levels at a point. Many images have smooth intensity variations, with the fine details being represented as sharp edges in between the smooth variations. The smooth variations in intensity may be termed as low frequency components and the sharp variations as high frequency components. The low frequency components (smooth variations) may comprise the gross information for an image, and the high frequency components may include information to add detail to the gross information. One technique for separating the low frequency components from the high frequency components may include a Discrete Wavelet Transform (DWT). Wavelet transforms may be used to decompose images, as well as other transforms, such as but not limited to a displaced frame difference transform to produce a displaced frame difference image. Wavelet decomposition may include the application of Finite Impulse Response (FIR) filters to separate image data into sub sampled frequency bands. The application of the FIR filters may occur in an iterative fashion, for example as described below in connection with FIGS. 4a through 4d.

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, processor based, or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

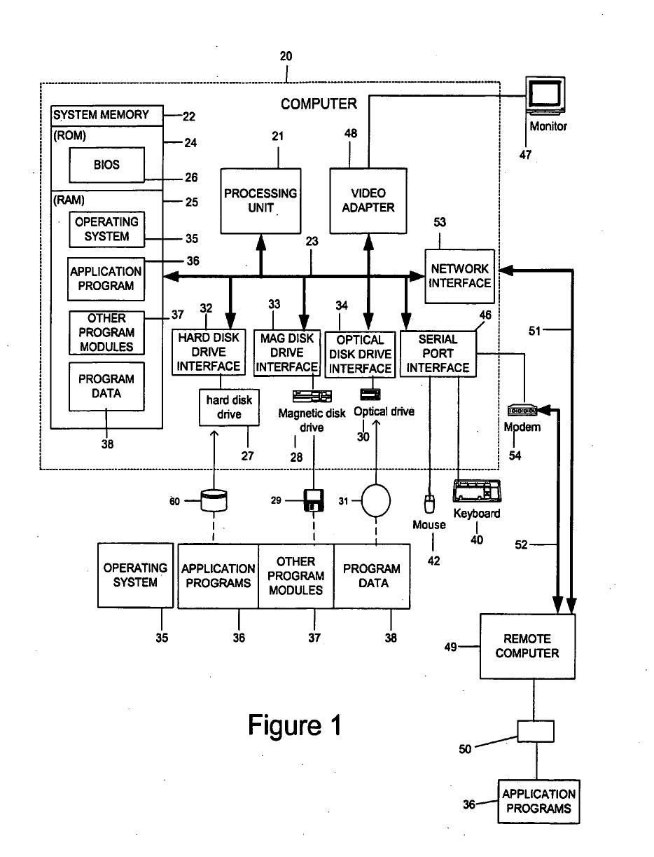

With reference to FIG. 1, one embodiment of a system for implementing the a method may include a general purpose computing device in the form of a computer 20, including a processing unit 21, a system memory 22, and a system bus 23 that may couple various system components including the system memory to the processing unit 21. The system bus 23 may be any of several types of bus structures including a memory bus or memory controller, a peripheral bus, and a local bus among many, which use any of a variety of bus architectures. The system memory may include read only memory (ROM) 24, random access memory (RAM) 25, and/or other memory. A basic input/output system (BIOS) 26, containing the basic routines that may help to transfer information between elements within the personal computer 20, such as during start-up, may be stored in ROM 24. The computer 20 may further include a hard disk drive 27 for reading from, and writing to, a hard disk 60, a magnetic disk drive 28 for reading from, or writing to, a removable magnetic disk 29, and an optical disk drive 30 for reading from, or writing to, a removable optical disk 31 such as a CD ROM or other media.

The hard disk drive 27, magnetic disk drive 28, and optical disk drive 30 may be connected to the system bus 23 by a hard disk drive interface 32, a magnetic disk drive interface 33, and/or an optical disk drive interface 34, respectively. The drives and their associated computer-readable media may provide nonvolatile storage of computer readable instructions, data structures, program modules and other data for computer 20. Although the exemplary environment described herein employs a hard disk 60, a removable magnetic disk 29, and a removable optical disk 31, it will be appreciated that other types of computer readable media which can store data that is accessible by a computer, such as magnetic cassettes, flash memory cards, digital video disks, random access memories, read only memories, and/or the like may also be used in the exemplary operating environment.

A number of program modules may be stored on the hard disk 60, magnetic disk 29, optical disk 31, ROM 24 or RAM 25, including an operating system 35, one or more applications programs 36, other program modules 37, and program data 38. A user may enter commands and information into computer 20 through input devices such as a keyboard 40 and a pointing device 42. Other input devices (not shown) may include a microphone, joystick, game pad, satellite dish, scanner, or the like. These and other input devices may be connected to the processing unit 21 through a serial port interface 46 that may be coupled to the system bus, but may be connected by other interfaces, such as a parallel port, wireless, game port, or a universal serial bus (USB), among other connection types. A monitor 47 or other type of display device may be also connected to the system bus 23 via an interface, such as a video adapter 48. In addition to the monitor, personal computers typically include other peripheral output devices, not shown, such as speakers and printers.

Computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to computer 20, although only a memory storage device 50 has been illustrated in FIG. 1. The logical connections depicted in FIG. 1 include a local area network (LAN) 51 and a wide area network (WAN) 52. Other networking systems and interfaces may be used.

When used in a LAN networking environment, computer 20 may be connected to the local network 51 through a network interface or adapter 53. When used in a WAN networking environment, the person computer 20 may include a modem 54 or other means for establishing communications over the WAN 52. The modem 54, which may be internal or external, may be connected to the system bus 23 via the serial port interface 46. In a networked environment, program modules depicted relative to computer 20, or portions thereof, may be stored in the remote memory storage device. It will be appreciated that the network connections shown are exemplary and other means of establishing a communications link between the computers may be used, including wireless, among many others.

In the description that follows, the systems and methods may be described with reference to acts and symbolic representations of operations that are performed by one or more computers. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that may have particular properties defined by the format of the data. However, while the disclosure is being described in the foregoing context, it is not meant to be limiting as it will be appreciated that various acts and operations described hereinafter may also be implemented in hardware.

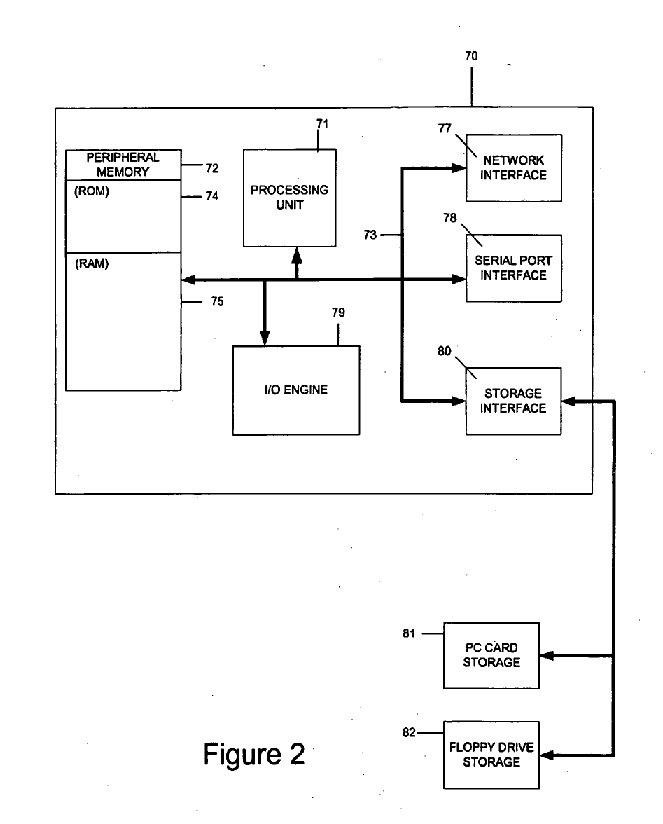

Turning to FIG. 2, an embodiment of an input/output device for implementing the systems and methods may include a general purpose peripheral 70, including a processing unit 71, a peripheral memory 72, and a peripheral bus 73 that may couple various peripheral components including the peripheral memory to the processing unit 71. The peripheral bus 73 may be any of several types of bus structures including a memory bus or memory controller, and a local bus using any of a variety of bus architectures, among many others. The peripheral memory may include read only memory (ROM) 74, random access memory (RAM) 75, and/or other memory.

The peripheral 70 may include a network interface 77, a serial port interface 78, or another type of interface, such as a Universal Serial Bus (USB) interface, a Small Computer System Interface (SCSI), or other interface. Many combinations of such interfaces can also be incorporated. The peripheral 70 also may include an input/output engine 79, which can operate on various principles depending on the nature of the peripheral. For example, a printer peripheral could contain a print engine such as ink jet printing, laser printing, dot matrix printing, daisy-wheel printing, thermal transfer printing, or dye sublimation printing. Alternatively, a scanner peripheral could provide for a scan engine such as negative scanning, flatbed scanning, handheld scanning, or digital photography. The peripheral 70 may also have additional storage, through the storage interface 80. Storage interface 80 may be connected to a PC card reader 81, a floppy drive 82, or any other internal or external storage device.

It will be appreciated that peripheral 70 could be a printer, a fax machine, a copier, a scanner, a digital camera, or other peripheral. The disclosure is not intended to be limited to any one type of peripheral.

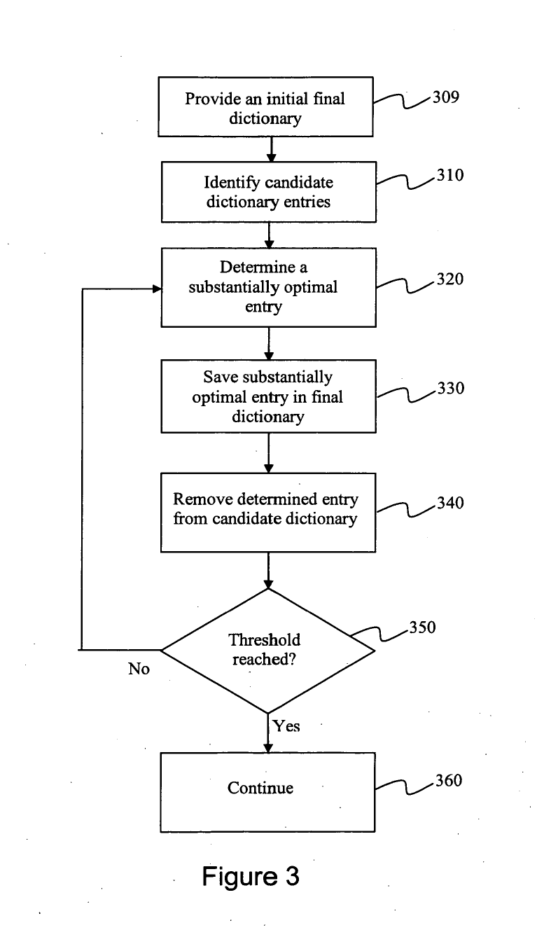

FIG. 3 is a flow diagram of one embodiment of a method for selecting a bases dictionary for image coding, such as coding utilizing wavelet transforms and matching pursuits. At block 309 an initial final dictionary is provided which may be empty or may contain entries previously determined such as the Dirac function (Unit impulse) which is known to be a generally useful codebook entry for many applications. At block 310, candidate dictionary entries are determined. Many different code books, and/or dictionary entries may be utilized within the candidate dictionary, as a starting point for selecting an optimal dictionary set for coding and decoding data. The candidate dictionary selection may depend upon the type of data to be coded. For instance, one set of dictionary entries may be utilized for audio data, and another for images. Similarly, one set of dictionary entries maybe utilized for a still image, and another for video images. Other entries may be utilized for other types of data.

At 320, the method may include determining the substantially best and/or optimal entry. This determination may be accomplished by calculating the maximum, or near the maximum inner product of each or some or nearly all entries from the candidate dictionary with the signal to be coded and/or a portion of the signal. In an exemplary embodiment, the data may be transformed, such as by discrete wavelet transform, before calculation of the inner product. In an embodiment, the data may be an image and may comprise a still image (or intra-frame), a motion-compensated residual image (Displaced Frame Difference (DFD) image, or inter-frame), or other type of image or data. The wavelet transform for this example embodiment may comprise a two-dimensional analysis, although the claimed subject matter is not limited in this respect.

The candidate entry with the largest or nearly largest inner product in magnitude may be called the substantially best or optimal entry. This substantially best or optimal entry may then be included in the final and/or optimal dictionary at 330. Furthermore, this substantially best or optimal entry may be removed from the candidate dictionary at 340. This removal may allow the next iteration to determine the 2^{nd} best candidate entry, etc.

At 350 if a threshold has been met, the “Yes” leg is followed to Continue at 360. If the threshold has not been met, the “No” leg is followed back to the determining the substantially best or optimal entry at 320. The threshold may be a certain number of entries in the optimal dictionary. It also may be a predetermined magnitude of the inner product found. The threshold also may be many other thresholds.

This method may produce a better final dictionary than if the entire candidate dictionary is utilized to code the signal, and the most used entries are put into the “optimal” dictionary. In this “popularity” method, the entries may “compete” with one another thereby reducing their effectiveness. The final dictionary may be better in that it has fewer entries, used more often, and/or reduces compression calculations, and/or bit rate and/or compression ratio. Furthermore, this method of this disclosure may produce a better codebook for virtually any coding that utilizes a codebook.

FIG. 4 shows a block diagram of an exemplary embodiment of a system, at 400. System 400 may include a candidate dictionary at 410. One design consideration may be which candidate dictionary entries to start with.

A selection module 420 may be configured to receive the entries from the candidate dictionary 410, and calculate the inner product between each entry and the signal to be coded 430. Selection module may then compare all the inner products calculated to determine the one with the largest or relatively large magnitude.

The entry that produces the substantially largest magnitude inner product may then be identified as the substantially best or optimal entry. This substantially best or optimal entry may then be saved to a final and/or substantially optimal dictionary 440. The substantially best or optimal entry may then be removed from the candidate dictionary 410. Selection module 420 may then calculate the inner product for the remaining candidate entries and find the largest, or near largest, magnitude inner product for the remaining entries. This process may be repeated until the threshold has been met.

An enhanced, final, and/or optimal bases dictionary may be determined by utilizing a candidate dictionary. The entries of the candidate dictionary may be utilized, along with a portion of a signal to be coded to find the maximum or substantially maximum inner product for each entry in the candidate dictionary. The entry with the heightened inner product may then be removed from the candidate dictionary and placed into an optimal and/or final dictionary. The maximum or substantially maximum inner products for the remaining entries from the candidate dictionary may be calculated similarly to find the one with the next largest, or nearly largest, inner product. This process may be continued until a threshold has been reached, such as a certain number of bases in the final dictionary, or where the maximum or nearly maximum inner product is below a predetermined value.

This final dictionary may be used on a signal, or data that has been transformed, such as a wavelet transform. Furthermore, the final dictionary may be utilized to code data with matching pursuits. This process may also be used with other data, including audio, visual, video, multidimensional, and/or non-transformed data. Furthermore, the final, optimal, and or near optimal dictionary may be used to code many different types of transformed and non-transformed data. Yet further, this method and system may be utilized to determine final, optimal, and or near optimal dictionaries and/or codebooks for many different types of data coding.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments.

In the foregoing specification claimed subject matter has been described with reference to specific example embodiments thereof. It will, however, be evident that various modifications and/or changes may be made thereto without departing from the broader spirit and/or scope of the subject matter as set forth in the appended claims. The specification and/or drawings are, accordingly, to be regarded in an illustrative rather than in a restrictive sense.

Some portions of the detailed description that follows are presented in terms of processes, programs and/or symbolic representations of operations on data bits and/or binary digital signals within a computer memory, for example. These algorithmic descriptions and/or representations may include techniques used in the data processing arts to convey the arrangement of a computer system and/or other information handling system to operate according to such programs, processes, and/or symbolic representations of operations.

A process may be generally considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It may be convenient at times, principally for reasons of common usage, to refer to these signals as bits, values, elements, symbols, characters, terms, numbers and/or the like. However, these and/or similar terms may be associated with the appropriate physical quantities, and are merely convenient labels applied to these quantities.

Unless specifically stated otherwise, as apparent from the following discussions, throughout the specification discussion utilizing terms such as processing, computing, calculating, determining, and/or the like, refer to the action and/or processes of a computing platform such as computer and/or computing system, and/or similar electronic computing device, that manipulate and/or transform data represented as physical, such as electronic, quantities within the registers and/or memories of the computer and/or computing system and/or similar electronic and/or computing device into other data similarly represented as physical quantities within the memories, registers and/or other such information storage, transmission and/or display devices of the computing system and/or other information handling system.

Embodiments claimed may include one or more apparatuses for performing the operations herein. Such an apparatus may be specially constructed for the desired purposes, or it may comprise a general purpose computing device selectively activated and/or reconfigured by a program stored in the device. Such a program may be stored on a storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and/or programmable read only memories (EEPROMs), flash memory, magnetic and/or optical cards, and/or any other type of media suitable for storing electronic instructions, and/or capable of being coupled to a system bus for a computing device, computing platform, and/or other information handling system.

The processes and/or displays presented herein are not inherently related to any particular computing device and/or other apparatus. Various general purpose systems may be used with programs in accordance with the teachings herein, or a more specialized apparatus may be constructed to perform the desired method. The desired structure for a variety of these systems will appear from the description below. In addition, embodiments are not described with reference to any particular programming language. It will be appreciated that a variety of programming languages may be used to implement the teachings described herein.

In the description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

What is claimed is:

1. A method of base selection, comprising:
identifying a candidate dictionary entry;
determining a substantially optimal candidate entry; and
saving the substantially optimal entry in a final dictionary.

2. The method of claim 1, further comprising removing the substantially optimal candidate entry from the candidate dictionary.

3. The method of claim 1, further comprising providing and initial final dictionary.

4. The method of claim 1, wherein the determining comprises finding a relatively maximum inner product of the candidate dictionary entry and a signal to be coded.

5. The method of claim 4, further comprising ending the process when a determined threshold has been reached.

6. The method of claim 4, wherein the threshold is a predetermined number of entries in the final dictionary.

7. The method of claims 5, wherein the threshold is a predetermined value for the relatively maximum inner product.

8. The method of claim 1, further comprising coding data based at least in part upon the final dictionary.

9. The method of claim 8, wherein coding data comprises performing matching pursuits.

10. The method of claim 8, further comprising discrete wavelet transforming the data.

11. The method of claim 8, wherein the data comprises a still image.

12. The method of claim 8, wherein the data comprises video.

13. The method of claim 8, wherein the data comprises an audio signal.

14. The method of claim 8, wherein the data comprises multidimensional data.

15. A method of bases selection, comprising:
identifying a candidate dictionary entry;
determining a substantially best candidate entry;
saving the substantially best candidate entry in a final dictionary;
removing the substantially best candidate entry from the candidate dictionary; and
utilizing the final dictionary for matching pursuits coding.

16. The method of claim 15, wherein the determining comprises finding a relatively maximum inner product of the candidate dictionary entry and a signal to be coded.

17. The method of claim 15, further comprising providing and initial final dictionary.

18. The method of claim 15, further comprising ending the process when a determined threshold has been reached.

19. The method of claim 18, wherein the threshold is a predetermined number of entries in the final dictionary.

20. The method of claims 19, wherein the threshold is a predetermined value for the relatively maximum inner product.

21. The method of claim 15, further comprising coding data based at least in part upon the final dictionary.

22. The method of claim 21, wherein coding data comprises performing matching pursuits.

23. The method of claim 21, wherein the data comprises data transformed by discrete wavelet transform.

24. An entry selection system, comprising:
a candidate dictionary;
a signal to be coded; and
a selection module configured to receive an entry from a candidate dictionary, to calculate an inner product between the entry and the signal to be coded, and to select the entry with a relatively maximum inner product for inclusion in a final dictionary.

25. The system of claim 24, further comprising an initial final dictionary.

26. The system of claim 24, wherein the signal to be coded is a wavelet transformed signal.

27. The system of claim 24, wherein the signal to be coded comprises a still image.

28. The system of claim 24, wherein the signal to be coded comprises video.

29. The system of claim 24, wherein the signal to be coded comprises an audio signal.

30. The system of claim 24, wherein the signal to be coded comprises multidimensional data.

31. The system of claim 24, wherein the final dictionary is utilized to code data.

32. An article of manufacture, comprising:
a machine accessible medium, the machine accessible medium providing instructions, that when executed by a machine, cause the machine to code data, with instructions comprising:
identifying a candidate dictionary entry;
determining an substantially optimal candidate entry; and
saving the substantially optimal candidate entry in a final dictionary.

33. The method of claim 32, further comprising providing and initial final dictionary.

34. The method of claim 32, further comprising removing the substantially optimal candidate entry from the candidate dictionary.

35. The method of claim 32, wherein the determining comprises finding a relatively maximum inner product of the candidate dictionary entry and a signal to be coded.

36. The method of claim 35, further comprising ending the process when a determined threshold has been reached.

37. The method of claim 36, wherein the threshold is a predetermined number of entries in the final dictionary.

38. The method of claims 37, wherein the threshold is a predetermined value for the relatively maximum inner product.

39. The method of claim 32, further comprising coding data based at least in part upon the final dictionary.

40. A system, comprising:
a means for identifying a candidate dictionary entry;
a means for determining a substantially best candidate entry;
a means for saving the substantially best candidate entry in a final dictionary;
a means for removing the substantially best candidate entry from the candidate dictionary; and
a means for utilizing the final dictionary for matching pursuits coding.
